(19) United States
(12) Patent Application Publication
(10) Pub. No.: US 2002/0112581 A1
(43) Pub. Date: Aug. 22, 2002

(54) Cutting apparatus

(76) Inventors: Chuan Sheng Lin, Taipei (TW); Ing-Kai Huang, Taipei (TW)

Correspondence Address: Chuan Sheng Lin, P.O. BOX 26-757, Taipei, 106, TW

(21) Appl. No.: 09/785,986

(22) Filed: Feb. 16, 2001

(51) Int. Cl. B26D 1/24

(52) U.S. Cl. 83/165; 83/500; 83/425.3

(57) ABSTRACT

A cutting apparatus comprises a casing, a driving mechanism and a roller set. The roller set comprises an upper roller, a middle roller and a lower roller parallel to each other and rollers have a plurality of major blades and rounded blade. The driving mechanism has a motor to rotate the rollers and has a reverse switch to change the rotation direction of the motor.

### FIELD OF THE INVENTION

The present invention relates to a cutting apparatus, especially to a cutting apparatus providing cutting in dual direction, i.e., longitudinal and transverse directions and having compact feature.

### BACKGROUND OF THE INVENTION

As computers become more and more popular, people like to print their own name card or greeting by computer and printer or even digital still camera. However, the printer generally prints paper with specific sizes such as A4 and B5, the paper printed from the printer requires a paper cutter or a blade to cut to a desired size for name card or greeting card. The cutting process is not precise and dangerous to hurt user's hand.

Alternatively, the paper printed from the printer can also be cut by industrial cutting apparatus. However, the industrial cutting apparatus are expensive and huge to hinder the household usage.

### SUMMARY OF THE INVENTION

It is the object of the present invention to provide a cutting apparatus performing cutting in dual direction, i.e., longitudinal and transverse directions and having compact feature.

To achieve above object, the cutting apparatus of the present invention comprises a casing, a driving mechanism and a roller set. The roller set comprises an upper roller, a middle roller and a lower roller parallel to each other and rollers have a plurality of major blades and rounded blade. The driving mechanism has a motor to rotate the rollers and has a reverse switch to change the rotation direction of the motor.

The various objects and advantages of the present invention will be more readily understood from the following detailed description when read in conjunction with the appended drawing, in which:

### BRIEF DESCRIPTION OF DRAWING

FIG. 1 shows the perspective view of the present invention;

FIG. 2 shows the internal view of the present invention;

FIG. 3 is a view showing the operation of the present invention;

FIG. 4 is another view showing the operation of the present invention;

FIG. 5 shows a sectional view along line A-A in FIG. 3;

FIG. 6 shows another preferred embodiment of the present invention; and

FIG. 7 shows a sectional view along line A-A in FIG. 6.

### DESCRIPTION OF THE INVENTION

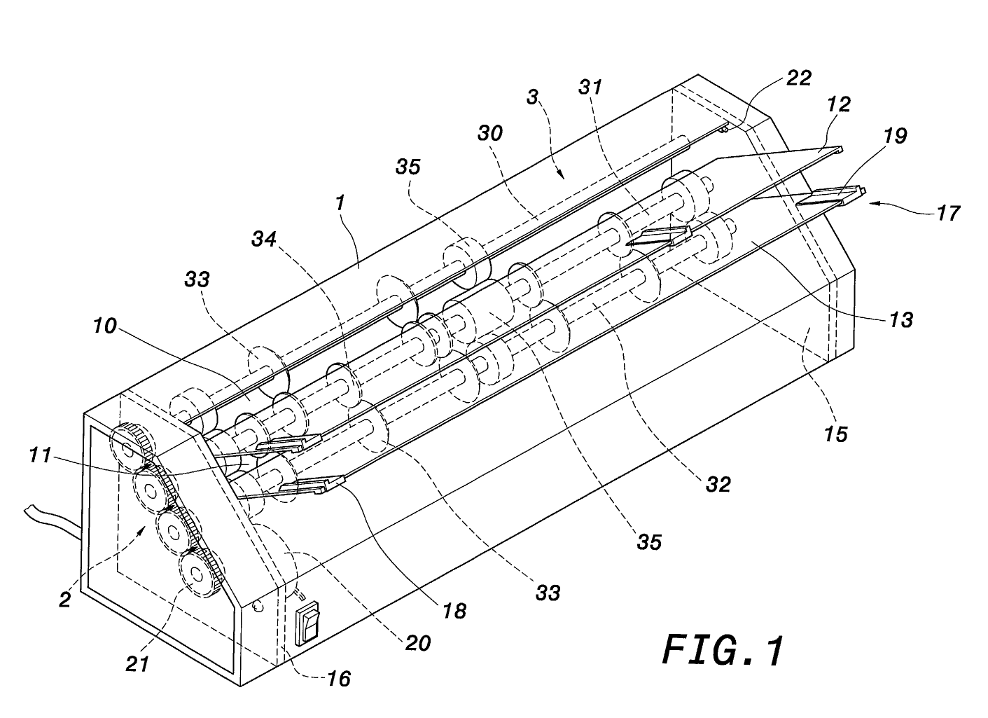

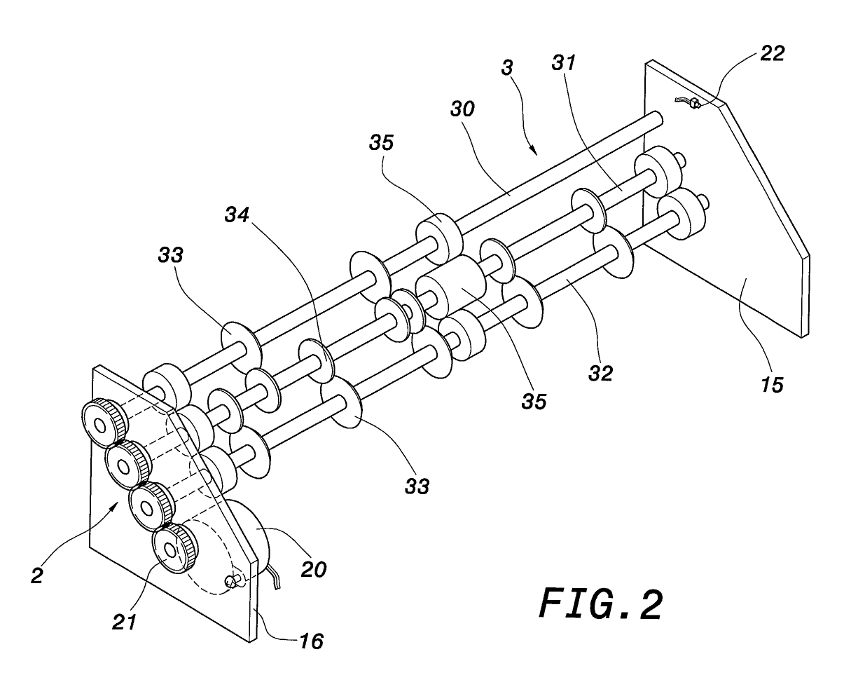

FIGS. 1 and 2 show the perspective and internal views of the present invention, respectively. The cutting apparatus provided by the present invention comprises a casing 1, a driving mechanism 2 and a roller set 3. The casing 1 comprises an upper feeding gutter 10 and a lower feeding gutter 11. The casing 1 further comprises an upper feeding plate 12 outside the upper feeding gutter 10; and a lower feeding plate 13 outside the lower feeding gutter 11. The upper feeding plate 12 and the lower feeding plate 13 are pivotally arranged on the casing 1 and provided with a clamping means 17. The clamping means 17 is composed of a fixed edge 18 and a movable edge 19. The fixed edge 18 is arranged on one side of the upper feeding plate 12 or one side of the lower feeding plate 13; and the movable edge 19 is slidable along the upper feeding plate 12 or one side of the lower feeding plate 13.

The roller set 3 is arranged within the casing and comprises an upper roller 30, a middle roller 31 and a lower roller 32. The upper roller 30, the middle roller 31 and the lower roller 32 are provided between two sidewalls 15 and 16 of the casing 1 and parallel to each other. The roller set 3 comprises a plurality of wheels 35 arranged on the upper roller 30, the middle roller 31 and the lower roller 32, respectively. Moreover, the upper roller 30 and the lower roller 32 are provided with a plurality of major blades 33 and the middle roller 31 has a plurality of rounded blades 34 corresponding to the major blades 33. The paper fed into the cutting apparatus of the present invention is cut in longitudinal direction (or transverse direction) between the upper roller 30 and the middle roller 31. The paper fed into the cutting apparatus of the present invention is cut in transverse direction (or longitudinal direction) between the middle roller 31 and the lower roller 32.

The driving mechanism 2 comprises a motor 20 and a plurality of gears 21 driven by the motor 20. The rollers 30, 31 and 32 are driven by the motor 20 through the gears 21. Moreover, the driving mechanism 2 further comprises a reverse switch 22 to control the rotation direction of the motor 20.

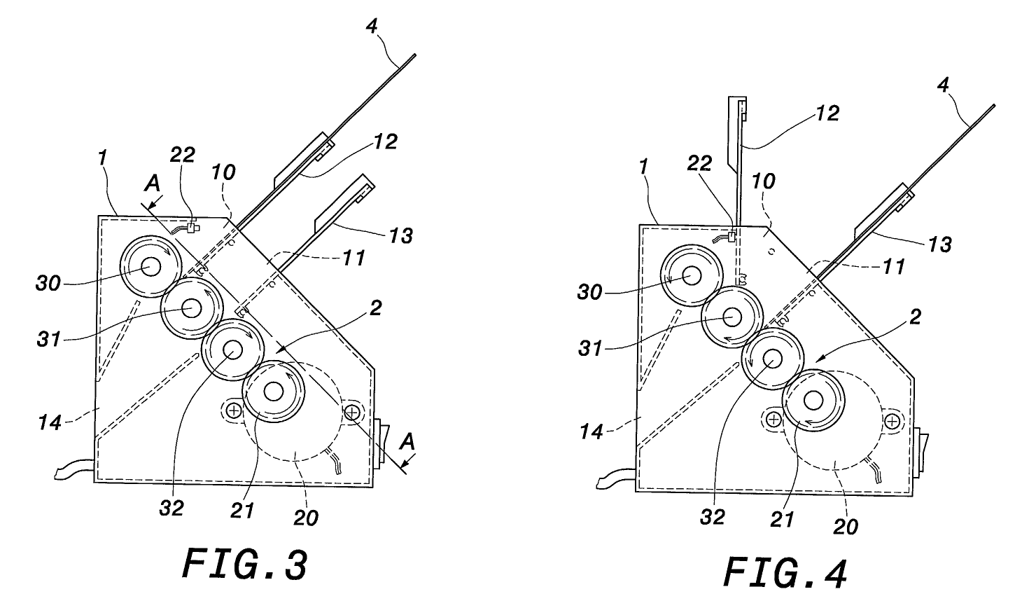

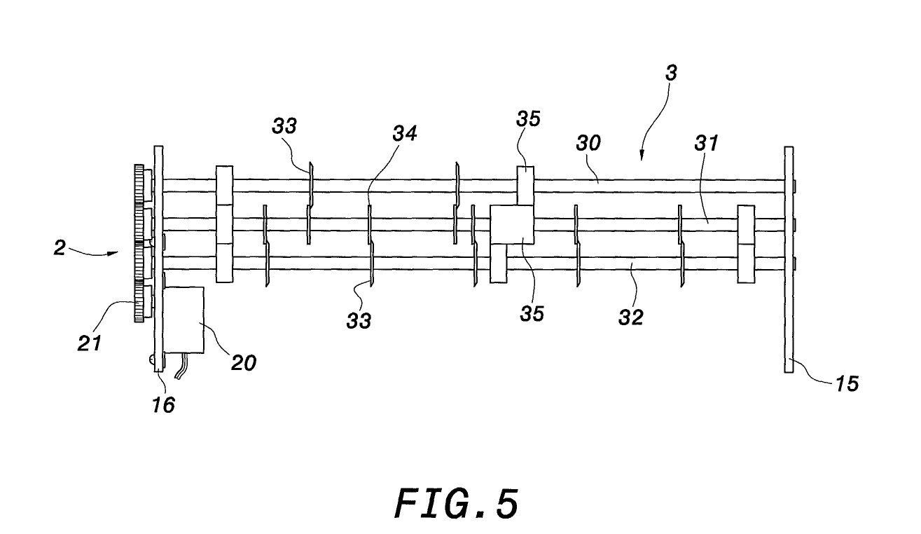

With reference now to FIGS. 3 and 5, to use the cutting apparatus of the present invention, the cutting apparatus is powered on and then the upper feeding plate 12 is placed horizontally. The paper 4 to be cut is placed on the upper feeding plate 12 and then fed into the casing 1 through the upper feeding gutter 10. At this time, the upper roller 30 has opposite rotation direction with the middle roller 31 such that the paper 4 is guided by the wheels 35 into the casing 1 for cutting in longitudinal direction (or transverse direction). Afterward, the cut paper 4 is left the cutting apparatus through a paper outlet 14. Moreover, at this time, the paper 4 cannot be conveyed by the wheel 35 between the middle roller 31 and the lower roller 32. Therefore, the paper 4 cannot be cut in transverse direction (or longitudinal direction).

With reference now to FIGS. 4 and 5, to cut the paper 4 in transverse direction (or longitudinal direction), the user presses the reverse switch 22 to control the rotation direction of the motor 20 to the reverse direction. At this time, the paper 4 can be conveyed by the wheel 35 between the middle roller 31 and the lower roller 32 and cut in transverse direction (or longitudinal direction). Alternatively, the upper feeding plate 12 can be rotated upward to press the reverse switch 22 to reverse the rotation direction of the motor 20. Therefore, the user does need to press the reverse switch 22 by additional effort.

By above operations, the paper 4 can be easily cut to desired sizes.

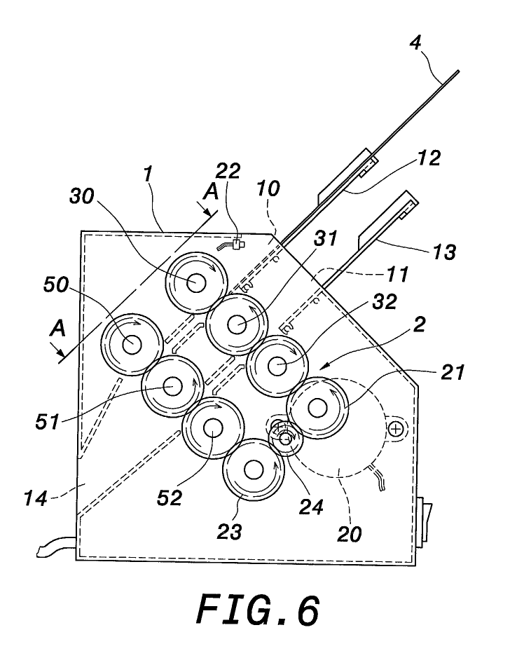

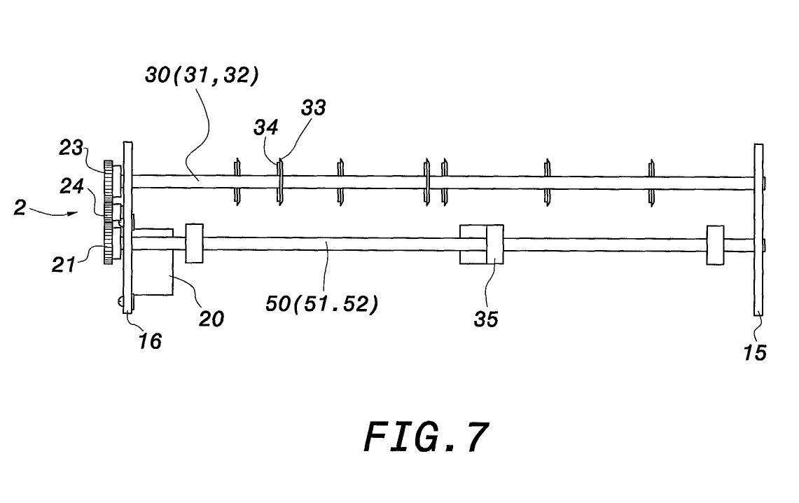

FIGS. 6 and 7 show another preferred embodiment of the present invention. The cutting apparatus according to another preferred embodiment of the present invention comprises an additional roller set 50. The roller set 5 comprises an upper roller 50, a middle roller 51 and a lower roller 52. Moreover, the major blade 33 and rounded blade 34 are arranged on the rollers 50, 51 and 52 in this preferred embodiment. The roller set 3 has only a plurality of wheels 35. The driving mechanism 2 further comprises an idler wheel 24 and a plurality of gears 23 to drive the roller set 5.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A cutting apparatus for cutting a paper, comprising
a casing comprising an upper feeding gutter, a lower feeding gutter and a paper outlet; and an upper feeding plate pivotally arranged outside the upper feeding gutter and a lower feeding plate pivotally arranged outside the lower feeding gutter;
a first roller set arranged within the casing and comprising an upper roller, a middle roller and a lower roller parallel to each other; the first roller set having a plurality of wheels on the rollers; the upper roller and the lower roller being provided with a plurality of major blades and the middle roller having rounded blade corresponding to the major blades; and
a driving mechanism having a motor to rotate the first roller set and a reverse switch to change the rotation direction of the motor.

2. The cutting apparatus as in claim 1, wherein each of the upper feeding plate and the lower feeding plate has a clamping means.

3. The cutting apparatus as in claim 1, wherein the clamping means is composed of a fixed edge and a movable edge.

4. The cutting apparatus as in claim 1, wherein the upper feeding plate can be rotated upward to press the reverse switch.

5. The cutting apparatus as in claim 1, wherein the paper is cut in longitudinal direction (or transverse direction) through the upper gutter between the upper roller and the middle roller; and the paper is cut in transverse direction (or longitudinal direction) through the lower gutter between the lower roller and the middle roller.

6. The cutting apparatus as in claim 1, wherein the motor drives the roller set through a plurality of gears.

7. The cutting apparatus as in claim 1, wherein the casing contains a second roller set having the major blade and the rounded blade; the first roller set having only a plurality of wheels.

8. The cutting apparatus as in claim 7, wherein the second roller set is driven by the motor through an idler wheel and a plurality of gears.
